(19) United States
(12) Patent Application Publication
(10) Pub. No.: US 2026/0236123 A1
(43) Pub. Date: Aug. 13, 2026

(54) STYLUS, TOUCH SYSTEM AND OPERATION METHOD OF TOUCH SYSTEM

(71) Applicant: BENQ CORPORATION, Taipei City (TW)

(72) Inventors: Chin-Jui Chi, Taipei City (TW); Yi-Huan Tsai, Taipei City (TW)

(21) Appl. No.: 19/277,405

(22) Filed: Jul. 23, 2025

(30) Foreign Application Priority Data
Feb. 13, 2025 (TW) 114105288

(51) Int. Cl. G06F 3/044; G06F 3/0354; G06F 3/041

(52) U.S. Cl. CPC G06F 3/0442; G06F 3/03545; G06F 3/04162

(57) ABSTRACT

A stylus, a touch system and an operation method of the touch system. The touch system includes the stylus and a touch device. The stylus includes a stylus identity and a plurality of designated operation functions. The stylus includes an infrared transmitter, the infrared transmitter is configured to transmit an infrared signal, and the infrared signal includes the stylus identity and one of the designated operation functions. The touch device includes an infrared receiver. The touch device includes a plurality of preset identities and a plurality of preset operation functions respectively corresponding to the preset identities. The touch device is configured to replace the preset operation function corresponding to the preset identity which is the same as the stylus identity with the designated operation function according to the infrared signal.

### CROSS-REFERENCE TO RELATED PATENT APPLICATION

This application claims the benefit of priority to Taiwan Patent Application No. 114105288, filed on Feb. 13, 2025. The entire content of the above identified application is incorporated herein by reference.

### FIELD OF THE DISCLOSURE

The present disclosure relates to a stylus, a touch system, and an operation method of the touch system, and more particularly to a stylus, a touch system, and an operation method of the touch system capable of changing functions at any time.

### BACKGROUND OF THE DISCLOSURE

With the development of technology, many electronic devices on the market use touch panels as operation input interfaces, such as smart phones, tablet computers, and laptops. Users can directly interact with the touch panel with their fingers. However, for quicker and more precise operation of the touch panel, many users also choose to use a stylus as an input tool for the touch panel.

Styluses can generally be divided into passive styluses and active styluses. Although passive styluses do not require batteries for operation, they can only perform writing and clicking functions.

The active stylus is provided with a wireless compatibility authentication (Wi-Fi) module, a Bluetooth module and a battery. The active stylus pen can send commands to an electronic device via the Wi-Fi module and the Bluetooth module so as to change the function of the active stylus. However, even when the user uses the active stylus only to write on the touch panel, the Wi-Fi module and the Bluetooth module are always in operation and continuously consume power, so that the battery life of the active stylus pen is limited.

### SUMMARY OF THE DISCLOSURE

In response to the above-referenced technical inadequacy, the present disclosure provides a stylus, a touch system and an operation method of the touch system.

The object of the present disclosure is to provide a stylus, a touch system and an operation method of the touch system, and the operation method can operate the stylus to transmit an infrared signal to the touch device to change its function.

In order to solve the above-mentioned problem, one of the technical aspects adopted by the present disclosure is to provide a stylus. The stylus includes an infrared transmitter. The infrared transmitter is configured to transmit an infrared signal. The stylus includes a stylus identity and a plurality of designated operation functions, and the infrared signal includes the stylus identity and one of the designated operation functions.

In order to solve the above-mentioned problem, another one of the technical aspects adopted by the present disclosure is to provide a touch system. The touch system includes a stylus and a touch system. The stylus includes a stylus identity and a plurality of designated operating functions. The stylus includes an infrared transmitter, and the infrared transmitter is configured to transmit an infrared signal. The infrared signal includes the stylus identity and one of the designated operating functions. The touch device includes an infrared receiver. The touch device includes a plurality of preset identities and a plurality of preset operation functions which respectively correspond to the preset identities. The touch device is configured to replace the preset operation function that corresponds to the preset identity that is the same as the stylus identity with the designated operation function according to the infrared signal.

In order to solve the above-mentioned problem, another one of the technical aspects adopted by the present disclosure is to provide an operation method of a touch system. The operation method comprises: providing a stylus, in which the stylus includes a stylus identity and a plurality of designated operation functions; providing a touch device, in which the touch device includes a plurality of preset identities and a plurality of preset operation functions which respectively correspond to the preset identities; transmitting an infrared signal by an infrared transmitter of the stylus, in which the infrared signal includes the stylus identity and one of the designated operation functions; receiving the infrared signal by an infrared receiver of the touch device; and replacing, by an operating system of the touch device, the preset operation function which corresponds to the preset identity that is the same as the stylus identity with the designated operation function according to the infrared signal.

Therefore, in the stylus, the touch system and the operation method of the touch system provided by the present disclosure, the infrared transmitter of the stylus is normally in a dormant state. A user can operate the stylus to transmit an infrared signal to the touch device to change the function of the stylus. Since the infrared transmitter is only switched from the dormant state to a working state when the user needs to change the function of the stylus, the power consumption of the stylus is relatively low and the stylus has a relatively long usage time.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a function block diagram of a stylus according to one embodiment of the present disclosure;

FIG. 2 is a function block diagram of a touch system according to a first embodiment of the present disclosure;

FIG. 3 is a function block diagram of a touch system according to a second embodiment of the present disclosure;

FIG. 4 is a flowchart of an operation method of the touch system according to the first embodiment of the present disclosure; and

FIG. 5 is a flowchart of an operation method of the touch system according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

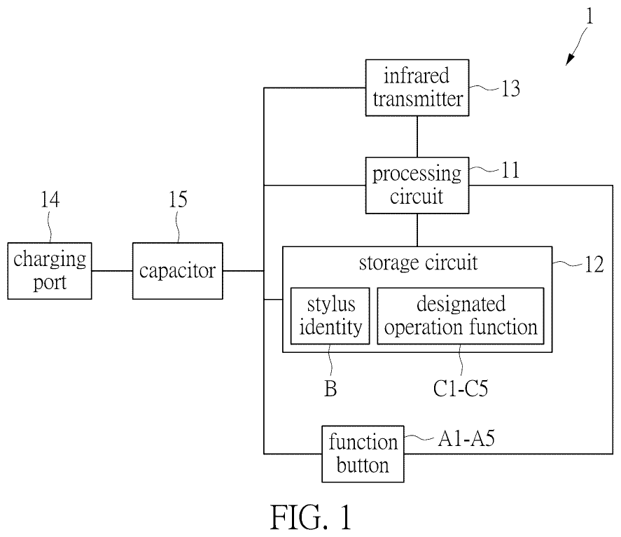

FIG. 1 is a function block diagram of a stylus according to one embodiment of the present disclosure. Referring to FIG. 1, the stylus 1 includes a processing circuit 11, a storage circuit 12, an infrared transmitter 13, a charging port 14, a capacitor 15, and a plurality of function buttons A1-A5. The range of the value of the capacitor 15, for example, is between 0.5 and 1. The capacitor 15 is electrically connected to the processing circuit 11, the storage circuit 12, the infrared transmitter 13 and the function buttons A1-A5 to provide power to the processing circuit 11, the storage circuit 12, the infrared transmitter 13 and the function buttons A1-A5. The charging port 14 is, for example, a USB Type C port. The charging port 14 is electrically connected to the capacitor 15. When the power stored in the capacitor 15 is insufficient to make the stylus 1 work, a user can connect the charging port 14 to an external power source, and the external power source charges the capacitor 15.

For example, the capacitor 15 can be a super/ultra capacitor or a gold capacitor. The super capacitor and the gold capacitor are used as low-power batteries, and the charging speed of each of the super capacitor and the gold capacitor is faster than that of a lithium battery on the market.

The processing circuit 11 is also electrically connected to the storage circuit 12, the infrared transmitter 13 and the function buttons A1-A5, and the user can operate the function buttons A1-A5. In other embodiments, the function buttons A1-A5 can be replaced by a dial or a lever.

The processing circuit 11 is, for example, a programmable logic controller circuit, a micro-processor circuit, a micro-control circuit or a central processing unit.

The storage circuit 12 is, for example, a random-access memory (RAM), a read only memory (ROM), a flash memory, a hard disk or other storage device that can be used to store data.

The storage circuit 12 stores a stylus identity B and a plurality of different designated operation functions C1-C5. The function buttons A1-A5 correspond to the designated operation functions C1-C5, respectively. The initial function of the stylus 1 may be the same as one of the designated operation functions C1-C5.

For example, the designated operation function C1 is a red writing function, the designated operation function C2 is a blue writing function, the designated operation function C3 is a black writing function, the designated operation function C4 is an eraser function, the designated operation function C5 is an object dragging function, and the initial function of the stylus 1 is the red writing function.

The infrared transmitter 13 is normally in a dormant state. The processing circuit 11 drives the infrared transmitter 13 to switch from the dormant state to a working state only when the user presses one of the function buttons A1-A5. The infrared transmitter 13 in the working state transmits an infrared signal that includes the stylus identity B and one of the designated operation functions C1-C5.

For example, the stylus identity B and the designated operation function C1 are represented by a first combination code. The stylus identity B and the designated operation function C2 are represented by a second combination code. The stylus identity B and the designated operation function C3 are represented by a third combination code. The stylus identity B and the designated operation function C4 are represented by a fourth combination code. The stylus identity B and the designated operation function C5 are represented by a fifth combination code.

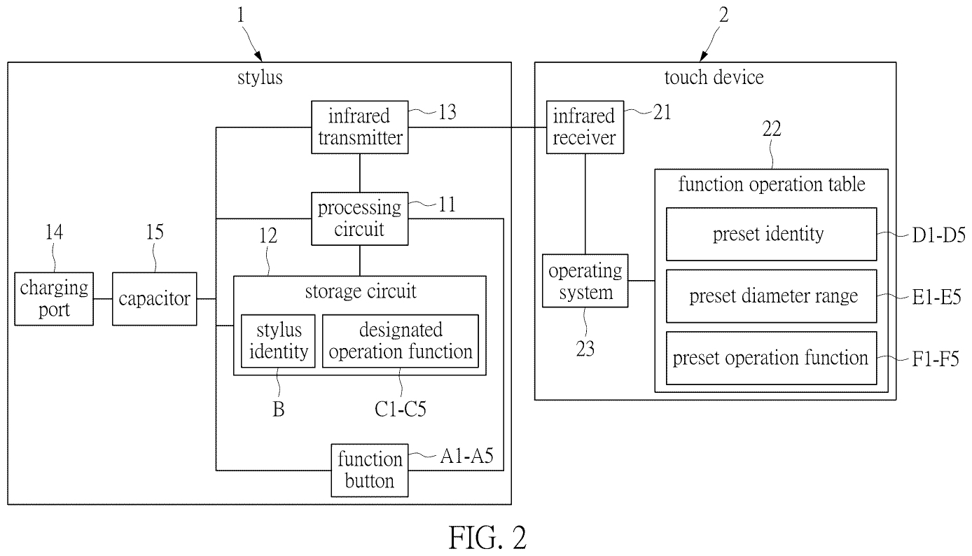

FIG. 2 is a function block diagram of a touch system according to a first embodiment of the present disclosure. Referring to FIG. 2, the touch system includes the stylus 1 and a touch device 2. The touch device 2 is, for example, a tablet computer or a laptop with a touch panel. The touch device 2 includes an infrared receiver 21, a function operation table 22 and an operating system 23. The infrared receiver 21 is configured to receive the infrared signal emitted by the stylus 1. The function operation table 22 includes a plurality of different preset identities D1-D5, a plurality of different preset diameter ranges E1-E5, and a plurality of different preset operation functions F1-F5. The preset pen diameter ranges E1-E5 correspond to the preset identities D1-D5, respectively. The preset identities D1-D5 correspond to the preset operation functions F1-F5, respectively.

When the user does not need to change the function of the stylus 1, the user directly brings the stylus 1 to come in contact with the touch panel of the touch device 2. At this time, the capacitance value of the touch panel of the touch device 2 is changed. The operating system 23 of the touch device 2 calculates the diameter of the stylus 1 according to an area where the capacitance value is changed. Then, the operating system 23 of the touch device 2 identifies whether the diameter of the stylus 1 matches one of the preset diameter ranges E1-E5. When the operating system 23 of the touch device 2 determines that the diameter of the stylus 1 matches one of the preset diameter ranges E1-E5, the operating system 23 of the touch device 2 provides one of the preset operating functions F1-F5 in response to the stylus 1.

For example, the preset diameter range E1 is between 1 millimeter and 3 millimeters (mm), the preset diameter range E2 is between 3 mm and 5 mm, the preset diameter range E3 is between 5 mm and 8 mm, the preset diameter range E4 is between 8 mm and 15 mm, and the preset diameter range E5 is between 15 mm and 18 mm. The preset operation function F1 is a black writing function, the preset operation function F2 is a red writing function, the preset operation function F3 is a blue writing function, the preset operation function F4 is an object dragging function, and the preset operation function F5 is an eraser function. When the stylus 1 with a diameter of 2.5 mm is contacted with the touch panel of the touch device 2, the operating system 23 of the touch device 2 identifies that the diameter of the stylus 1 meets the preset diameter range E1. Since the preset diameter range E1 corresponds to the preset identity D1 and the preset identity D1 corresponds to the preset operation function F1, the operating system 23 of the touch device 2 provides the preset operation function F1 in response to the stylus 1. At this time, the stylus 1 can write in black on the touch panel of the touch device 2.

For example, when the stylus 1 with a diameter of 10 mm is contacted with the touch panel of the touch device 2, the operating system 23 of the touch device 2 identifies that the diameter of the stylus 1 meets the preset diameter range E4. Since the preset diameter range E4 corresponds to the preset identity D4 and the preset identity D4 corresponds to the preset operation function F4, the operating system 23 of the touch device 2 provides the preset operation function F4 in response to the stylus 1. At this time, the stylus 1 can drag an image object displayed on the touch panel of the touch device 2.

When the user needs to change the function of the stylus 1, the user can press one of the function buttons A1-A5 before the stylus 1 is contacted with the touch panel of the touch device 2, so that the processing circuit 11 drives the infrared transmitter 13 to switch from the dormant state to the working state. The infrared transmitter 13 in working state transmits an infrared signal to the touch device 2, the infrared signal including the stylus identity B and one of the designated operation functions C1-C5.

In one example, the stylus 1 is initially a black writing pen. When the user presses the function button A1, an infrared signal emitted by the infrared transmitter 13 of the stylus 1 includes the stylus identity B and the designated operation function C1, in which the designated operation function C1 is a red writing function. When the infrared receiver 21 of the touch device 2 receives the infrared signal emitted by the stylus 1, the operating system 23 of the touch device 2 identifies that the stylus identity B is the same as the preset identity D1, and the operating system 23 of the touch device 2 changes the preset operation function F1 corresponding to the preset identity D1 to the designated operation function C1. Since the designated operation function C1 is a red writing function, the stylus 1 is changed from a black writing pen to a red writing pen.

In another example, the stylus 1 is initially a blue writing pen. When the user presses the function button A4, the infrared transmitter 13 of the stylus 1 transmits an infrared signal including the stylus pen identity B and the designated operation function C4. When the infrared receiver 21 of the touch device 2 receives the infrared signal emitted by the stylus 1, the operating system 23 of the touch device 2 identifies that the stylus identity B is the same as the preset identity D3, and the operating system 23 of the touch device 2 changes the preset operation function F3 corresponding to the preset identity D3 to the designated operation function C4. Since the designated operation function C4 is an eraser function, the function the stylus 1 is changed from a blue writing pen to an eraser.

In another example, the stylus 1 is initially a red writing pen. When the user presses the function button A5, an infrared signal emitted by the infrared transmitter 13 of the stylus 1 includes the stylus pen identity B and the designated operation function C5. When the infrared receiver 21 of the touch device 2 receives the infrared signal emitted by the stylus 1, the operating system 23 of the touch device 2 identifies that the stylus identity B is the same as the preset identity D2, and the operating system 23 of the touch device 2 changes the preset operation function F2 corresponding to the preset identity D2 to the designated operation function C5. Since the designated operation function C5 is the object dragging function, the stylus 1 is changed from a red writing pen to a pen capable of dragging image objects displayed on the touch panel.

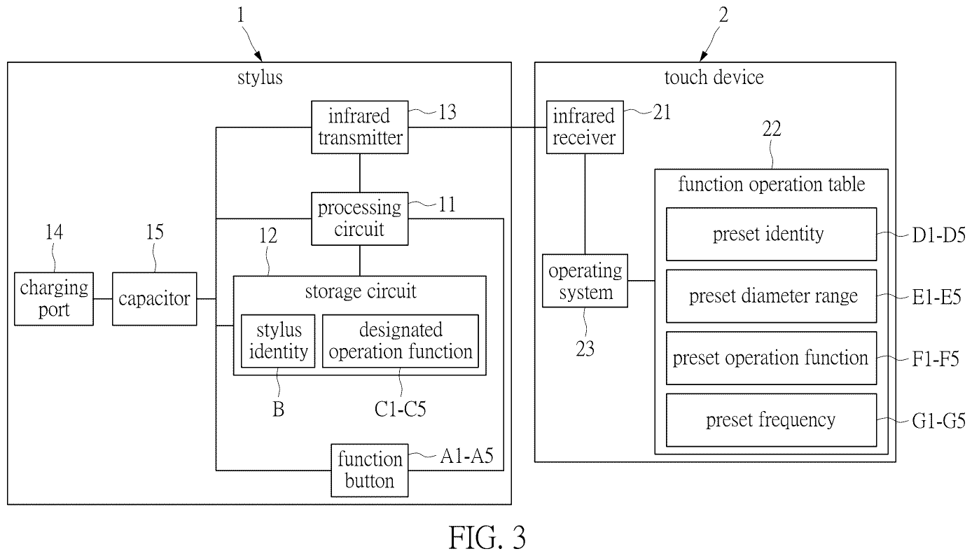

FIG. 3 is a function block diagram of a touch system according to a second embodiment of the present disclosure. Differences between the touch system of FIG. 3 and the touch system of FIG. 2 are described below. The frequency of the infrared signal emitted by the infrared transmitter 13 of the stylus 1 depends on the diameter of the stylus 1. For example, the frequency of the infrared signal emitted by the stylus 1 whose diameter is less than 3 mm is 36 kHz, and the frequency of the infrared signal emitted by the stylus 1 whose diameter is greater than 3 mm and less than 5 mm is 38 kHz.

The function operation table 22 of the touch device 2 further includes a plurality of preset frequencies G1-G5, and the preset frequencies G1-G5 correspond to the preset identities D1-D5, respectively. The operating system 23 of the touch device 2 identifies whether the frequency of the infrared signal of the stylus 1 matches one of the preset frequencies G1-G5. When the frequency of the infrared signal of the stylus 1 matches one of the preset frequencies G1-G5, the stylus identity B of the stylus 1 matches one of the preset identities D1-D5, and then the touch device 2 changes the initial function of the stylus 1 according to the infrared signal.

For example, when the user presses the function button A1 of the stylus 1 with a diameter of 2.5 mm, the infrared transmitter 13 of the stylus 1 transmits an infrared signal to the touch device 2, and the infrared signal includes the stylus identity B and the designated operation function C1. The infrared receiver 21 of the touch device 2 receives the infrared signal, and the operating system 23 of the touch device 2 determines that the frequency of the infrared signal matches the preset frequency G1 of the function operation table 22. Since the preset frequency G1 corresponds to the preset identity D1, and the preset identity D1 corresponds to the preset operation function F1, the operating system 23 of the touch device 2 changes the preset operation function F1 of the function operation table 22 to the designated operation function C1.

Regarding other embodiments of the touch system, the touch system may include a plurality of styluses 1 with different diameters and the touch control device 2, and the styluses 1 may simultaneously perform different functions on the touch panel of the touch control device 2.

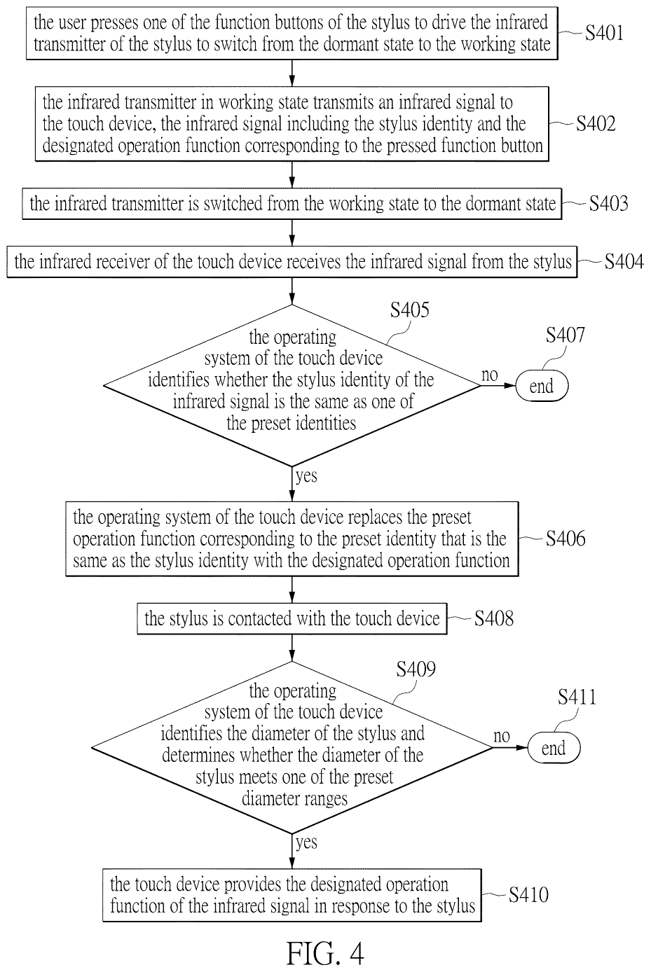

FIG. 4 is a flowchart of an operation method of the touch system according to a first embodiment of the present disclosure. Referring to FIG. 2 and FIG. 4, in step S401, the user presses one of the function buttons A1-A5 of the stylus 1 to drive the infrared transmitter 13 of the stylus 1 to switch from the dormant state to the working state.

In step S402, the infrared transmitter 13 in working state transmits an infrared signal to the touch device 2, the infrared signal including the stylus identity B and the designated operation function corresponding to the pressed function button. For example, when the user presses the function button A1, the infrared signal emitted by the infrared transmitter 13 includes the stylus identity B and the designated operation function C1.

In step S403, the infrared transmitter 13 is switched from the working state to the dormant state. Specifically, every time the infrared transmitter 13 transmits the infrared signal, the infrared transmitter 13 is switched from the working state to the dormant state, thereby saving the power of the stylus 1.

In step S404, the infrared receiver 21 of the touch device 2 receives the infrared signal from the stylus 1.

In step S405, the operating system 23 of the touch device 2 identifies whether the stylus identity B of the infrared signal is the same as one of the preset identities D1-D5. If yes, the operation method proceeds to step S406. If not, the operation method ends (step S407).

In step S406, the operating system 23 of the touch device 2 replaces the preset operation function corresponding to the preset identity that is the same as the stylus identity B with the designated operation function. For example, the operating system 23 of the touch device 2 identifies that the stylus identity B is the same as the preset identity D1, and then the operating system 23 of the touch device 2 replaces the preset operation function F1 corresponding to the preset identity D1 with the designated operation function C1.

In step S408, the stylus 1 is contacted with the touch device 2.

In step S409, the operating system 23 of the touch device 2 identifies the diameter of the stylus 1 and identifies whether the diameter of the stylus 1 meets one of the preset diameter ranges E1-E5. If yes, the operation method proceeds to step S410. If not, the operation method ends (step S411).

In step S410, the touch device 2 provides the designated operation function C1 of the infrared signal in response to the stylus 1. For example, the operating system 23 of the touch device 2 identifies that the diameter of the stylus 1 is within the preset diameter range E1. Since the preset diameter range E1 corresponds to the preset identity D1 and the preset identity D1 corresponds to the specified operation function C1, the operating system 23 of the touch device 2 provides the specified operation function C1 in response to the stylus 1.

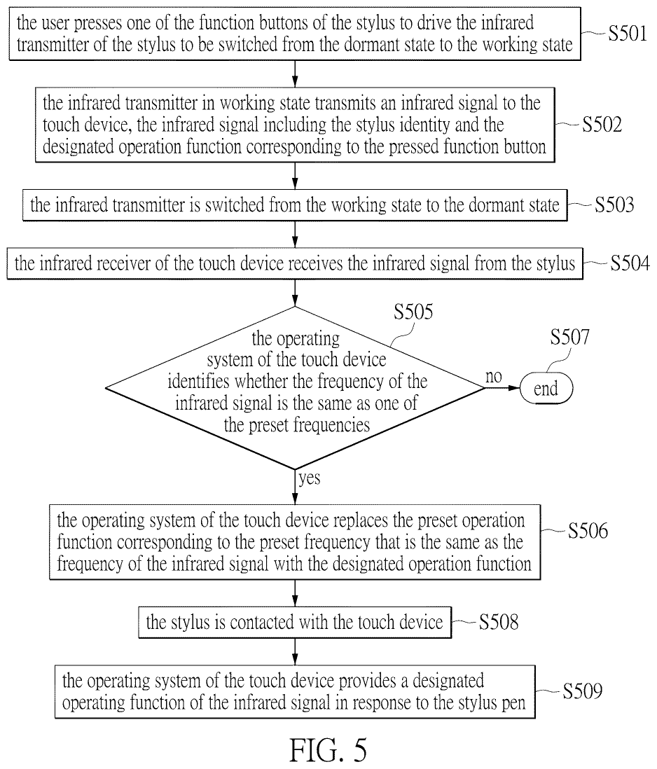

FIG. 5 is a flowchart of an operation method of the touch system according to a second embodiment of the present disclosure. Referring to FIG. 3 and FIG. 5, in step S501, the user presses one of the function buttons A1-A5 of the stylus 1 to drive the infrared transmitter 13 of the stylus 1 to be switched from the dormant state to the working state.

In step S502, the infrared transmitter 13 in working state transmits an infrared signal to the touch device 2, the infrared signal including the stylus identity B and the designated operation function corresponding to the pressed function button.

In step S503, the infrared transmitter 13 is switched from the working state to the dormant state.

In step S504, the infrared receiver 21 of the touch device 2 receives the infrared signal from the stylus 1.

In step S505, the operating system 23 of the touch device 2 identifies whether the frequency of the infrared signal is the same as one of the preset frequencies G1-G5. If yes, the operation method proceeds to step S506. If not, the operation method ends (step S507).

In step S506, the operating system 23 of the touch device 2 replaces the preset operation function corresponding to the preset frequency that is the same as the frequency of the infrared signal with the designated operation function. For example, the operating system 23 of the touch device 2 determines that the frequency of the infrared signal emitted by the stylus 1 is the same as the preset frequency G2. In the function operation table 22, the preset frequency G2 corresponds to the preset identity D2 and the preset identity D2 corresponds to the preset operation function F2, so that the operating system 23 of the touch device 2 replaces the preset operation function F2 corresponding to the preset identity D2 with the designated operation function C1.

In step S508, the stylus 1 is contacted with the touch device 2.

In step S509, the operating system 23 of the touch device 2 provides a designated operating function of the infrared signal in response to the stylus pen 1. Specifically, the operating system 23 identifies that the infrared signal emitted by the stylus 1 is the same as the preset frequency G2. Since the preset frequency G2 corresponds to the preset identity D2 and the preset identity D2 corresponds to the specified operation function C2, the operating system 23 of the touch device 2 provides the specified operation function C2 in response to the stylus 1.

Since the diameter of the stylus 1 is smaller, the operating system 23 of the touch control device 2 is more likely to misjudge the diameter of the stylus 1, thereby misjudging the identity of the stylus 1. The operating system 23 of the touch device 2 can more accurately confirm the identity of the stylus 1 by determining the frequency of the infrared signal.

### Beneficial Effects of the Embodiments

In conclusion, in the stylus, the touch system and the operation method of the touch system provided by the present disclosure, the touch system includes the stylus and the touch device. The stylus includes the infrared transmitter configured to transmit the infrared signal. The stylus includes the stylus identity and the designated operation functions. The infrared signal includes the stylus identity and one of the designated operation functions. The touch device includes the infrared receiver. The touch device includes the preset identities and the preset operation functions which respectively correspond to the preset identities. The touch device is configured to replace the preset operation function corresponding to the preset identity that is the same as the stylus identity with the designated operation function according to the infrared signal. The infrared transmitter of the stylus is normally in the dormant state. The user can operate the stylus to transmit the infrared signal to the touch device to change the function of the stylus. Since the infrared transmitter is switched from the dormant state to the working state only when the user needs to change the function of the stylus, the power consumption of the stylus is low and the stylus has a relatively long usage time.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A stylus, comprising:
an infrared transmitter configured to transmit an infrared signal, wherein the stylus comprises a stylus identity and a plurality of designated operation functions, and the infrared signal comprises the stylus identity and one of the designated operation functions.

2. The stylus according to claim 1, further comprising a processing circuit and a storage circuit, wherein the processing circuit is electrically connected to the infrared transmitter and the storage circuit, the processing circuit is configured to transmit the stylus identity and one of the designated operation functions to the infrared transmitter, and the storage circuit stores the stylus identity and the designated operation functions.

3. The stylus according to claim 1, further comprising a charging port and a capacitor, wherein the charging port is configured to be connected to an external power source, and the capacitor is electrically connected to the charging port and the infrared transmitter.

4. The stylus according to claim 1, further comprising a processing circuit and a plurality of function buttons, wherein the processing circuit is electrically connected to the function buttons and the infrared transmitter, and the function buttons correspond to the designated operation functions, respectively.

5. A touch system, comprising:
a stylus, wherein the stylus comprises an infrared transmitter, the infrared transmitter is configured to transmit an infrared signal, the stylus comprises a stylus identity and a plurality of designated operating functions, and the infrared signal comprises the stylus identity and one of the designated operating functions; and
a touch device, wherein the touch device comprises an infrared receiver, the touch device comprises a plurality of preset identities and a plurality of preset operation functions respectively corresponding to the preset identities, the touch device is configured to replace the preset operation function that corresponds to the preset identity that is the same as the stylus identity with the designated operation function according to the infrared signal.

6. The touch system according to claim 5, wherein the stylus further comprises a processing circuit and a storage circuit, the processing circuit is electrically connected to the infrared transmitter and the storage circuit, the processing circuit is configured to transmit the stylus identity and one of the designated operation functions to the infrared transmitter, and the storage circuit stores the stylus identity and the designated operation functions.

7. The touch system according to claim 5, wherein the stylus further comprises a charging port and a capacitor, wherein the charging port is configured to be connected to an external power source, and the capacitor is electrically connected to the charging port and the infrared transmitter.

8. The touch system according to claim 5, wherein the stylus further comprises a processing circuit and a plurality of function buttons, wherein the processing circuit is electrically connected to the function buttons and the infrared transmitter, and the function buttons correspond to the designated operation functions, respectively.

9. The touch system according to claim 5, further comprising a function operation table, wherein the function operation table comprises corresponding relationships related to the preset identities, a plurality of different preset pen diameter ranges, and the preset operation functions.

10. The touch system according to claim 5, wherein, when the stylus is contacted with the touch device, the touch device provides the designated operation function of the infrared signal in response to the stylus.

11. The touch system according to claim 5, wherein the touch device further comprises a plurality of preset frequencies, the preset frequencies correspond to the preset identities respectively, and the touch device is configured to replace the preset operation function that corresponds to the preset frequency that is the same as a frequency of the infrared signal with the designated operation function.

12. An operation method of a touch system, comprising:
providing a stylus, wherein the stylus comprises a stylus identity and a plurality of designated operation functions;
providing a touch device, wherein the touch device comprises a plurality of preset identities and a plurality of preset operation functions which respectively correspond to the preset identities;
transmitting an infrared signal by an infrared transmitter of the stylus, wherein the infrared signal comprises the stylus identity and one of the designated operation functions;
receiving the infrared signal by an infrared receiver of the touch device;
and replacing, by an operating system of the touch device, the preset operation function which corresponds to the preset identity that is the same as the stylus identity with the designated operation function according to the infrared signal.

13. The operation method according to claim 12, wherein the touch device further comprises a plurality of preset diameter ranges, the preset diameter ranges respectively correspond to the preset identities, the operating system of the touch device identifies a diameter of the stylus and identifies one of the preset diameter ranges that the diameter of the stylus is in.

14. The operation method according to claim 12, further comprising:
transmitting, by a processing circuit of the stylus, one of the designated operation functions and the stylus identity to the infrared transmitter.

15. The operation method according to claim 12, further comprising: connecting a charging port of the stylus with an external power source; receiving power from the external power source by a capacitor of the stylus; and providing the power of the external power source to the infrared transmitter by the capacitor.

16. The operation method according to claim 12, further comprising: generating the designated operation function by operating one of a plurality of function buttons of the stylus.

17. The operation method according to claim 12, wherein the touch device comprises a function operation table, the function operation table comprises corresponding relationships related to the preset identities, a plurality of different preset diameter ranges and the preset operation functions.

18. The operation method according to claim 12, further comprising: contacting the touch device with the stylus; and providing the designated operation function of the infrared signal by the touch device in response to the stylus.

19. The operation method according to claim 12, further comprising: defining a plurality of preset frequencies by the touch device, wherein the preset frequencies respectively correspond to the preset identities; and replacing, through the touch device, the preset operation function that corresponds to the preset frequency that is the same as a frequency of the infrared signal with the designated operation function.

20. The operation method according to claim 12, further comprising: operating one of a plurality of function buttons of the stylus; and driving, through a processing circuit of the stylus, the infrared transmitter to be switched from a dormant state to a working state.
